(19) United States
(12) Patent Application Publication
(10) Pub. No.: US 2025/0146402 A1
(43) Pub. Date: May 8, 2025

(54) METHOD OF GEOSTEERING BASED ON FORMATION DIELECTRIC PROPERTIES ESTIMATED FROM LOGGING WHILE DRILLING MEASUREMENTS

(71) Applicant: Baker Hughes Oilfield Operations LLC, Houston, TX (US)

(72) Inventors: Salah Mohammed Al-Ofi, Khobar (SA); Jun Zhang, Katy, TX (US); Stewart Blake Brazil, Edmond, OK (US)

(21) Appl. No.: 18/938,622

(22) Filed: Nov. 6, 2024

Related U.S. Application Data
(60) Provisional application No. 63/547,427, filed on Nov. 6, 2023.

(51) Int. Cl. E21B 44/00; E21B 7/06; E21B 47/026

(52) U.S. Cl. CPC E21B 44/00; E21B 7/06; E21B 47/026

(57) ABSTRACT

A borehole system performs a method for identifying a pay zone in a formation. A processor measures a first dielectric constant of the formation at a selected depth or depth interval in a borehole in the formation using a first electromagnetic wave or signal transmitted through the formation at the selected depth or depth interval at a first frequency, measures a second dielectric constant of the formation at the selected depth or depth interval in the borehole in the formation using a second electromagnetic wave or signal transmitted through the formation at the selected depth or depth interval at a second frequency, and identifies the pay zone in the formation based on the first dielectric constant at the selected depth or depth interval and the second dielectric constant at the selected depth or depth interval.

### CROSS REFERENCE TO RELATED APPLICATIONS

This application claims the benefit of an earlier filing date from U.S. Provisional Application Ser. No. 63/547,427 filed Nov. 6, 2023, the entire disclosure of which is incorporated herein by reference.

### BACKGROUND

In the resource recovery industry, a drill string is used to drill a borehole in an earth formation and to locate the presence of hydrocarbons in the formation. The drill string can have a logging-while-drilling tool that includes various sensors that can be used to determine parameters of the formation. In particular, an electric tool can be used to measure formation resistivity, which can be used to determine a depth at which hydrocarbons are present in the formation. For some formations, however, resistivity is not a useful parameter for determining the presence of hydrocarbons particularly when resistivity contrast between hydrocarbon-bearing zones and non-hydrocarbon bearing zones is minimal or prior knowledge of formation's properties are unknown, e.g. fluids resistivity and formation's porosity. Thus, it is desirable to provide a method for employing an electric tool that can be used to determine a parameter other than resistivity that can be used to identify hydrocarbons in these formations.

### SUMMARY

Disclosed herein is a method for identifying a pay zone in a formation. A first dielectric constant of the formation is measured at a selected depth or depth interval in a borehole in the formation using a first electromagnetic wave or signal transmitted through the formation at the selected depth or depth interval at a first frequency. A second dielectric constant of the formation is measured at the selected depth or depth interval in the borehole in the formation using a second electromagnetic wave or signal transmitted through the formation at the selected depth or depth interval at a second frequency. The pay zone is identified based on the first dielectric constant at the selected depth or depth interval and the second dielectric constant at the selected depth or depth interval.

Disclosed herein is a borehole system including a processor. The processor is configured to measure a first dielectric constant of the formation at a selected depth or depth interval in a borehole in the formation using a first electromagnetic wave or signal transmitted through the formation at the selected depth or depth interval at a first frequency, measure a second dielectric constant of the formation at the selected depth or depth interval in the borehole in the formation using a second electromagnetic wave or signal transmitted through the formation at the selected depth or depth interval at a second frequency, and identify a pay zone in the formation based on the first dielectric constant at the selected depth or depth interval and the second dielectric constant at the selected depth or depth interval.

### BRIEF DESCRIPTION OF THE DRAWINGS

The following descriptions should not be considered limiting in any way. With reference to the accompanying drawings, like elements are numbered alike:

FIG. 1 shows a borehole system in an illustrative embodiment;

FIG. 2 shows an electric tool of a drill string of the borehole system, in an illustrative embodiment;

FIGS. 3A-3D show illustrative logs that can be obtained from a formation using formation sensors of the drill string;

FIG. 4 shows a graph of dielectric constant values vs. frequency for various depths in a borehole;

FIGS. 5A-5D show various logs obtained from a formation in which resistivity is not suitable for determining a presence of hydrocarbon, for illustrative purposes;

FIG. 6 is a flowchart of a method for detecting a hydrocarbon pay zone at a depth in a borehole; and

FIG. 7 is a flowchart of another method for detecting hydrocarbon at a depth in a borehole.

### DETAILED DESCRIPTION

A detailed description of one or more embodiments of the disclosed apparatus and method are presented herein by way of exemplification and not limitation with reference to the Figures.

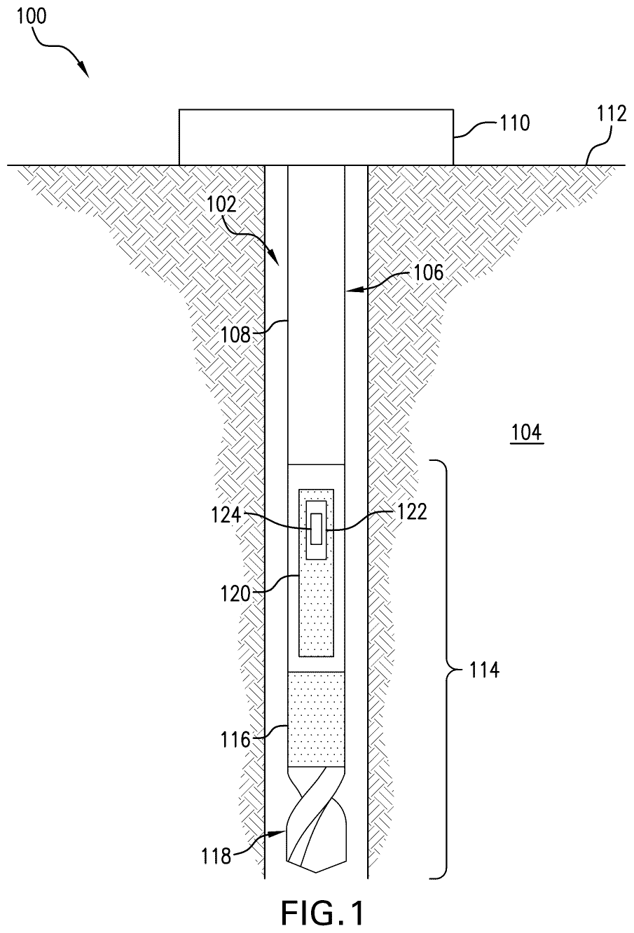

Referring to FIG. 1, a borehole system 100 is disclosed in an illustrative embodiment. The borehole system 100 includes a borehole 102 penetrating a subsurface formation 104. A drill string 106 is disposed within the borehole 102. The drill string 106 includes a tubular 108 extending from a drilling platform 110 at a surface location 112. The tubular 108 includes a bottomhole assembly (BHA) 114 including a steering unit 116, a drill bit 118 and one or more formation sensors 120 for measuring various properties of the formation. The formation sensors 120 can include an electric tool for measuring electrical properties of the formation 104, such as resistivity, conductivity, a dielectric constant, etc. Other formation sensors can include a gamma ray sensor, for example. A controller 122 receives data from the formation sensors and determines a location of a hydrocarbon in the formation from the data. The controller 122 includes a processor 124 for performing various operations of the controller disclosed herein. The controller 122 can send a signal to the steering unit 116 to steer the drill string 106 based on the presence or location of hydrocarbon, such as by steering the drill string toward a hydrocarbon pay zone (i.e., a depth, depth interval, or a range of depths in the borehole at which hydrocarbon is determined to be located). In addition, or alternatively, the controller 122 can send a signal to the surface equipment for a human operator to send commands to the steering unit 116 to steer the drill string 106 based on the signal by the controller 122. The controller 122 can also send a signal to surface equipment that control other drilling parameter, such as revolutions per minute (RPM) of the drill string 106, weight on bit (WOB), etc. The controller 122 can be disposed on the drill string 106 or at the drilling platform 110 at the surface location 112.

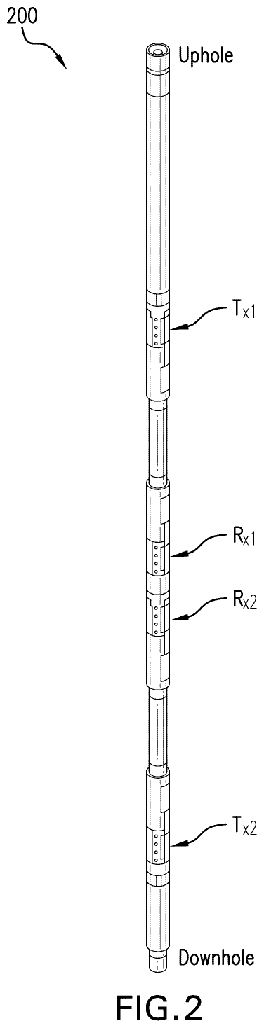

FIG. 2 shows an electric tool 200 of the drill string 106, in an illustrative embodiment. The electric tool 200 includes a pair of transmitters TX₁, TX₂ and receivers RX₁, RX₂. The transmitters TX₁, TX₂ are disposed at opposite ends along a longitudinal axis of the electric tool 200. The receivers RX₁, RX₂ are disposed between the transmitters TX₁, TX₂ on the electric tool 200 and are separated from each other by a gap. The transmitters TX₁, TX₂ generate one or more electromagnetic waves or electromagnetic signals that propagate through the formation 104. After propagation through the formation 104, the electromagnetic waves or signals are received at the receivers RX₁, RX₂. The received signals can be sent to the processor 124. The processor 124 determines various properties of the formation 104 and communicates information that is used to control an operation of the drill string, such as steering, based on the properties. Although two transmitters and two receivers are shown in FIG. 2, it is understood that the electric tool 200 can have any number of transmitters and any number of receivers in various configurations and arrangements (e.g., asymmetric configurations) in alternative embodiments.

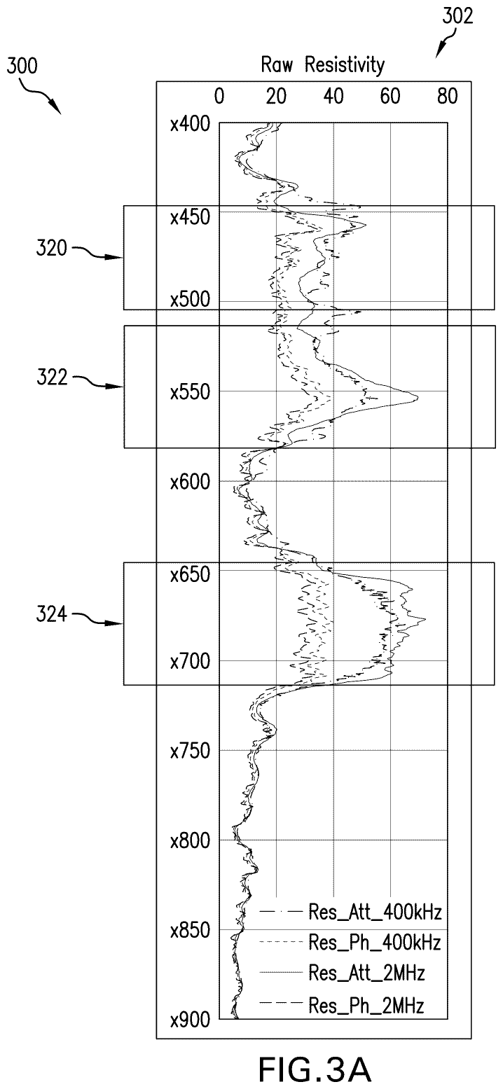

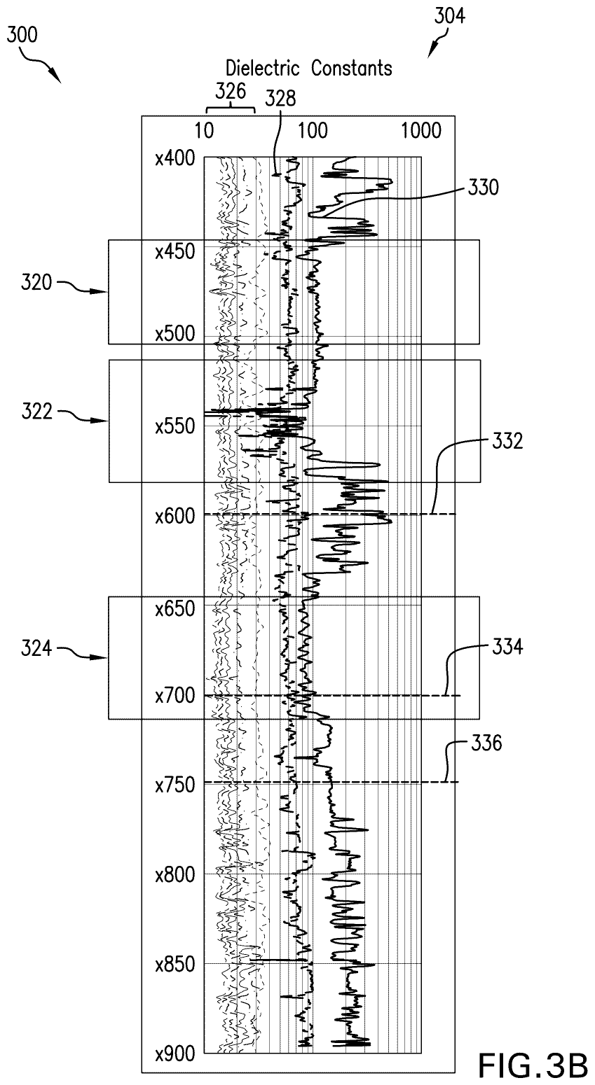

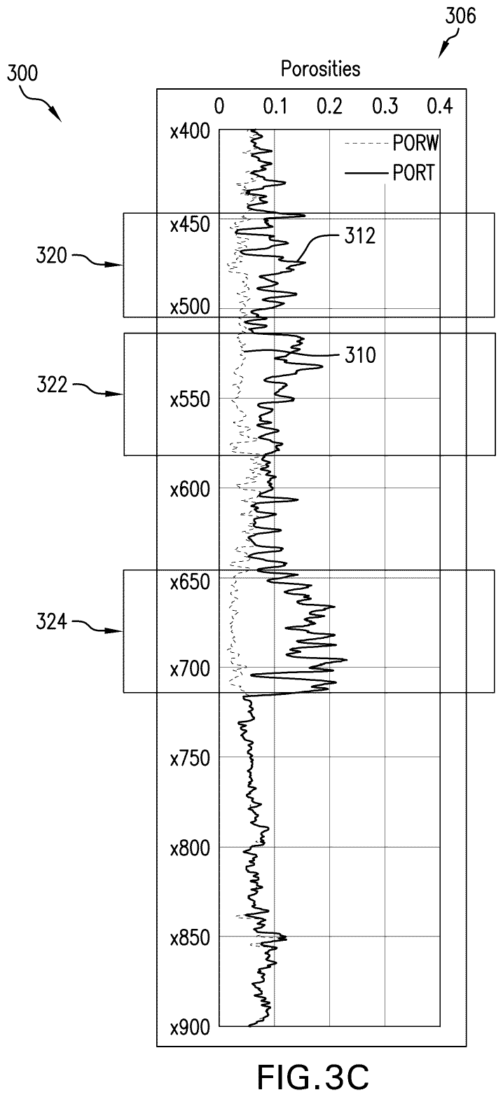

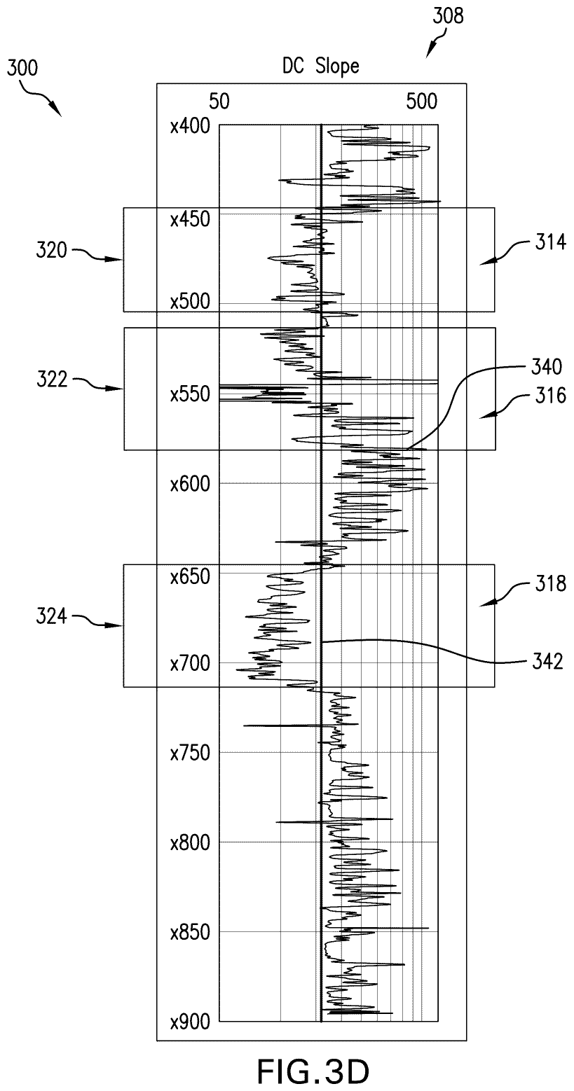

FIGS. 3A-3D shows various logs 300 that can be obtained from a formation using the formation sensors 120, for illustrative purposes. The logs 300 include a resistivity log 302 (FIG. 3A), a dielectric constant log 304 (FIG. 3B) (obtained from both logging while drilling (LWD) and wireline measurements), a wireline porosity log 306 (FIG. 3C), and a dielectric constant slope log 308 (FIG. 3D) (obtained from LWD measurements). While, in this disclosure, resistivity and dielectric constant are chosen to describe the electric measurements, those skilled in the art will appreciate that there are various ways to describe the electric measurements depending on the used definitions. For example, it is well known that the resistivity is the inverse of the conductivity and, thus, can be replaced by the conductivity leading to the same or similar information when using the resistivity. Also, in some embodiments, rather than using resistivity/conductivity and dielectric constant, the electrical measurement may also be known as or related to the imaginary and real part of the permittivity (sometimes also referred to as dielectric constant), respectively, and/or the real and imaginary part of the conductivity, respectively. Notably, the dielectric constant as used is only a name for a physical quantity and does not imply that the physical quantity is constant in any way and in particular not with respect to variations in one or more of frequency, resistivity/conductivity, temperature, pressure, and/or one or more material properties (such as material properties of the subsurface formation).

The wireline porosity log 306 can be used to determine the presence of hydrocarbons at a depth in the formation. The wireline porosity log 306 includes a water porosity curve 310 and a total porosity curve 312. The water porosity curve 310 (PORW) can be obtained using a wireline multi-frequency multi-array dielectric tool and the total porosity (PORT) can be obtained using a neutron/density tool.

The total porosity is a sum of the water porosity and the hydrocarbon porosity. A difference or separation between the water porosity curve 310 and the total porosity curve 312 at a given depth can therefore indicate the presence of hydrocarbons at that depth. Thus, the wireline porosity log 306 indicates a first hydrocarbon pay zone 314 that extends from a depth of about x450 feet to about x500 feet. The wireline porosity log 306 also indicates a second hydrocarbon pay zone 316 that extends from a depth of about x510 feet to about x580 feet as well as a third hydrocarbon pay zone 318 that extends from a depth of about x650 feet to about x720 feet.

The resistivity log 302 can also be used to determine the presence of a hydrocarbon pay zone for this formation or to confirm the presence of the pay zone indicated by the porosity log. The resistivity log 302 includes resistivity measurements obtained using electromagnetic waves or signals transmitted into the formation 104 at various frequencies. The resistivity typically rises in the presence of hydrocarbon. Thus, regions 320, 322 and 324 of increased resistivity indicates the presence of hydrocarbons at pay zones 314, 316 and 318. The resistivity log 302 can be used on its own or together with the wireline porosity log 306 to confirm the presence of the hydrocarbon pay zones 314, 316 and 318 indicated by the wireline porosity log 306.

Referring now to the dielectric constant log 304, seven dielectric curves are shown. Each dielectric curve includes values of dielectric constants obtained over a range of depths and at a designated frequency. Five dielectric curves 326 are obtained using a wireline dielectric tool (not shown) after drilling. Curves 328 and 330 are values of dielectric constants obtained using the LWD electric tool of the drill string 106 at LWD operating frequencies. For illustrative purposes, curve 330 is obtained using an electromagnetic wave or signal having a frequency of about 400 kilohertz (kHz) and curve 328 is obtained using an electromagnetic wave or signal having a frequency of about 2 Megahertz (MHz). The LWD dielectric constant curves can be used to determine the presence of a pay zone using the methods disclosed herein.

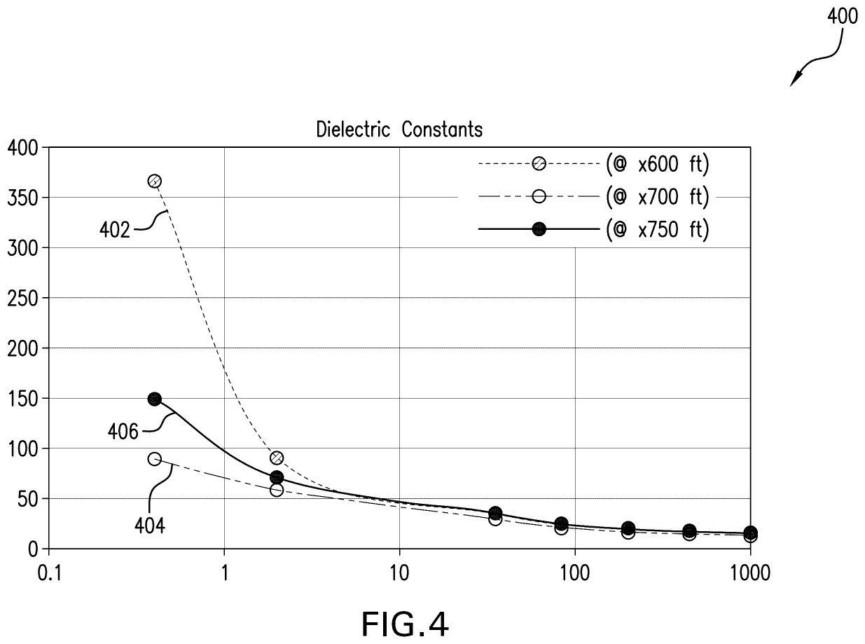

FIG. 4 shows a graph 400 of dielectric constant values vs. frequency at various depths. The data shown is from the same data sets as illustrated in FIGS. 3A-3D. Frequency is shown along the abscissa on a logarithmic scale and relative dielectric constant values are shown along the ordinate axis, (The relative dielectric constant is the ratio of the measured dielectric constant to the dielectric constant of free space and so is a unitless quantity). Dielectric curves are shown for data obtained at separate depths within the borehole. Each curve includes values of dielectric constants obtained via both wireline (such as curves 326 in FIG. 3B) and LWD (such as curves 328, 330 in FIG. 3B). A first dielectric curve 402 includes values of the dielectric constant obtained at a depth of x600 feet. A second dielectric curve 404 includes values of the dielectric constant obtained at a depth of x700 feet. A third dielectric curve 406 includes values of the dielectric constant obtained at a depth of x750 feet.

Referring to FIGS. 3A-3D, a depth of x600 (line 332) is outside of a hydrocarbon pay zone and a depth of x750 (line 336) is outside of a hydrocarbon pay zone. A depth of x700 feet (line 334) is within a pay zone (i.e., within the third hydrocarbon pay zone 318).

Referring back to FIG. 4, the slope of a curve indicates whether the associated depth is within a pay zone. Specifically, a curve with a flat or little slope corresponds to a depth at which a hydrocarbon pay zone is present. A dielectric constant slope (of a dielectric curve) can be determined using the values of dielectric constant for a plurality of frequencies. The frequencies can be selected from a range from about 1 kHz to about 30 MHz. In an embodiment, measurements of dielectric constant can be obtained at 100 kHz, 400 kHz and 2 MHz. In another embodiment, measurements can be obtained at 1 kHz, 2 kHz, 5 kHz, 8 kHz, 10 kHz, 20 kHz, 50 kHz and 80 kHz. The dielectric constant slope can be calculated based on dielectric constant values at these frequencies. In an embodiment, the slope line can be determined using a regression analysis.

For illustrative purposes, the dielectric constant slope is determined for dielectric constant values obtained at a first frequency and at a second frequency. Those skilled in the art will understand that the waves or signals having the first frequency and the second frequency may be transmitted simultaneous through the formation and creating a wave or signal that contains both, the first and the second frequency. Alternatively, a wave or signal with the first frequency may be transmitted through the formation alternately with a wave or signal with the second frequency. In a non-limiting embodiment, the dielectric constant slope can be defined as shown in Eq. (1):

$$DS = \vert \frac{{log}_{10} ( {ε}_{f 1} ) - {log}_{10} ( {ε}_{f 2} )}{{log}_{10} ( {ε}_{f 2} )} \vert * 1000 \qquad Eq . ( 1 )$$

where DS is the dielectric constant slope, ϵ_{ƒ1} is the dielectric constant at frequency ƒ₁ and ε_{ƒ2} is the dielectric constant at frequency ƒ₂. ε_{ƒ1} and ε_{ƒ2} may be measured values, for example, or may be values calculated from measured values such as, but not limited to, averages, maxima, minima, etc. For the illustrative embodiment disclosed herein, the first frequency is 400 kHz and the second frequency is 2 MHZ. To determine the presence of a pay zone, the DS can be compared to one or more slope thresholds. A pay zone is determined at a depth when the dielectric constant slope of the curve associated with the depth is less than a first slope threshold and as long as the dielectric constant slope crosses a second slope threshold. In one embodiment, the first and second slope threshold are the same. In other embodiments, the first and second threshold may be different and the second slope threshold may be larger than the first threshold. The dielectric constant slope is shown as being a difference between logarithms of a first value of dielectric constant for a first frequency and a second value of dielectric constant for a second frequency. In other embodiments, the dielectric constant slope can be calculated by using a logarithm with one or more different bases, or a difference between values, without use of logarithms. In a different embodiment, the subtraction of (logarithms of) dielectric constants may be replaced by a ratio of (logarithms of) dielectric constants. Alternatively or in addition, the difference of (the logarithms of) the first value of the dielectric constant for the first frequency and the second value of the dielectric constant for the second frequency may not be taken in relative to log₁₀(ε_{ƒ2}) but to one or more different values, such as, for example log₁₀(ε_{ƒ1}) or any other value such as, for example, a constant or a constant that does not depend on ε_{ƒ2} or ε_{ƒ2} but depends on other quantities or parameter, like, for example, conductivity, resistivity (e.g., conductivity, resistivity measured at one or both of the first and second frequencies), temperature, pressure, etc. In yet another embodiment, there can be an assignment that is not an analytical function of ε_{ƒ1} and ε_{ƒ2} but defined, for example by a table that defines each pair of ε_{ƒ1} and ε_{ƒ2} values a DS parameter that may be close to one or more of the analytic functions discussed above. Those skilled in the art will understand that such a table may be realized by a computer program or similar that assigns each pair of ε_{ƒ1} and ε_{ƒ2} values a predefined DS parameter.

The first dielectric curve 402 has a first dielectric constant slope that is the highest among the three slopes of curves 402, 404, 406 and the third dielectric curve 406 has a dielectric constant slope that is also high although not as steep as for the first dielectric curve 402. The second dielectric curve 404 has a relatively flat dielectric constant slope. The slope threshold is selected to distinguish between a dielectric constant slope indicative of a pay zone (e.g., second dielectric curve 404) and dielectric constant slopes are not associated with a pay zone (e.g., first dielectric curve 402 and third dielectric curve 406).

Referring back to FIGS. 3A-3D, the dielectric constant slope log 308 shows values of dielectric constant slope determined using Eq. (1) at each of the logging depths. Curve 340 shows the dielectric constant slope values vs. depth. Line 342 is the slope threshold. The dielectric constant slope log 308 shows that the dielectric constant slope values (curve 340) are substantially below the slope threshold (line 342) in each of the first hydrocarbon pay zone 314, second hydrocarbon pay zone 316 and third hydrocarbon pay zone 318. Notably, the dielectric constant slope log 308 provides this information with only one curve, rather than a plurality of curves to derive the zonation of the reservoir. Also, the dielectric constant slope log 308 can be measured with the same tool as, for example, the resistivity logs 300, such as electric tool 200 using the same sensor assembly that is used to create resistivity logs 300. This implies that the dielectric constant slop log 308 can be measured while the borehole system 100 is drilling and, thus, the zonation (e.g., zone information comprising hydrocarbon pay zones 314, 316, 318) can be utilized to steer the borehole system 100 through the formation 104. In one or more embodiments, the analysis whether a hydrocarbon pay zone is drilled or not will be performed downhole, such as in bottomhole assembly 114 and only this information, rather than the actual DS values is sent uphole to the drilling platform 110 where it is used to generate steering commands which are sent to the bottomhole assembly 114 and steering unit 116. In other embodiments, the information concerning whether a hydrocarbon pay zone is drilled or not is sent to the downhole processor 124 to generate steering commands automatically which are sent to the steering unit 116. Thus, an autonomous steering system based on DS measurements is created.

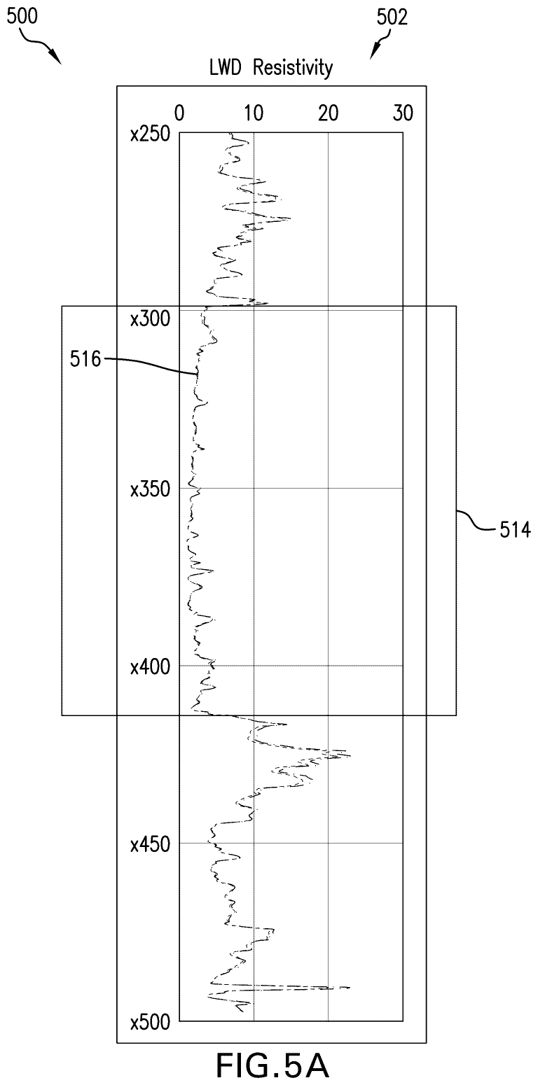

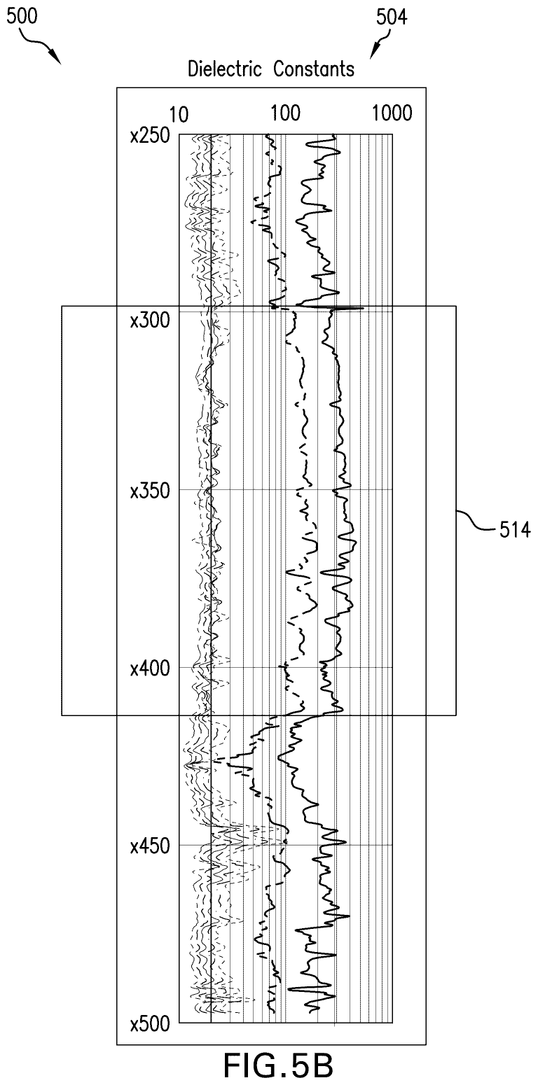

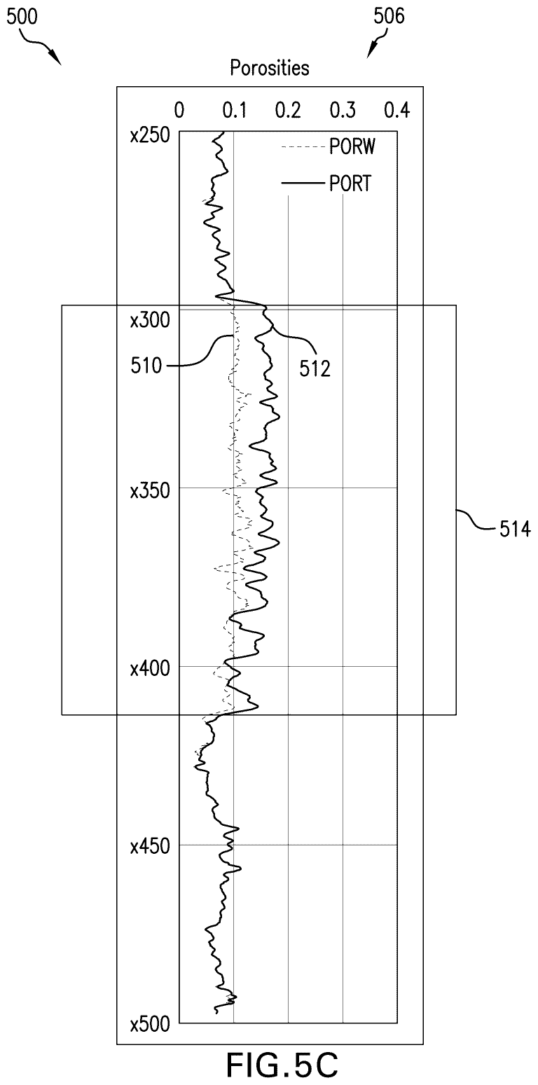

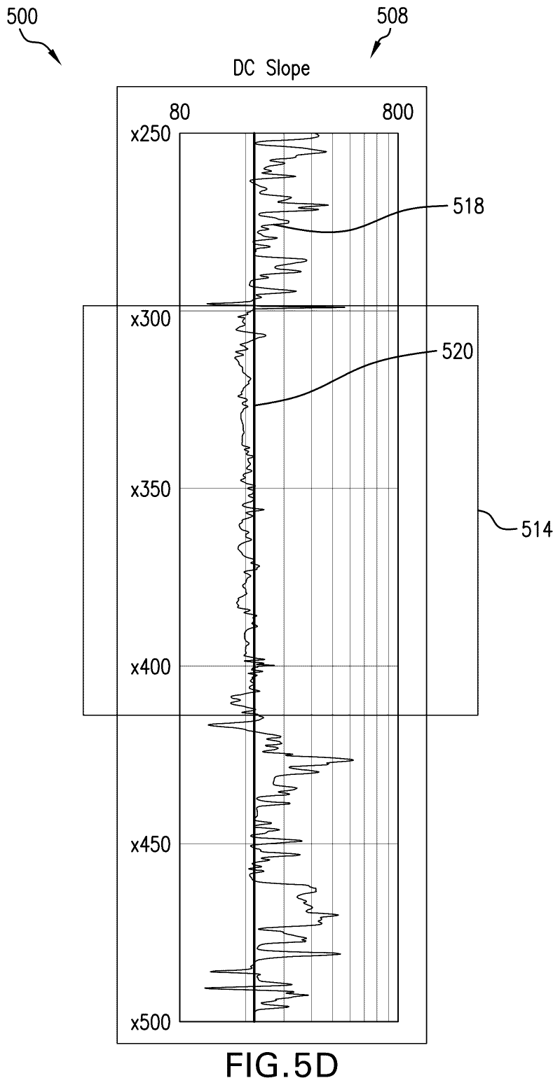

FIGS. 5A-5D shows various logs 500 obtained of a formation in which resistivity is not sufficient for determining a presence of hydrocarbon, (a low resistivity pay zone), in an illustrative embodiment. The logs 500 include a resistivity log 502 (FIG. 5A), a dielectric constant log 504 (FIG. 5B), a porosity log 506 (FIG. 5C), and a dielectric constant slope log 508 (FIG. 5D).

In the porosity log 506, the water porosity curve 510 and the total porosity curve 512 indicate the presence of a hydrocarbon pay zone 514 between the depths of about x300 feet and about x415 feet. However, the resistivity curves 516 in resistivity log 502 show low resistivity at these depths and therefore do not confirm the presence of the hydrocarbon pay zone 514.

The dielectric constant slope log 508 shows a dielectric constant slope curve 518 determined from the curves of the dielectric constant log 504 using Eq. (1) at each of the logging depths. The dielectric constant slope log 508 includes dielectric constant slope curve 518 and slope threshold 520. The dielectric constant slope curve 518 is less than the slope threshold 520 at depths within the hydrocarbon pay zone 514. Therefore, the dielectric constant slope curve 518 can be used to identify a hydrocarbon pay zone, even when a resistivity log 502 is unable to identify the pay zone.

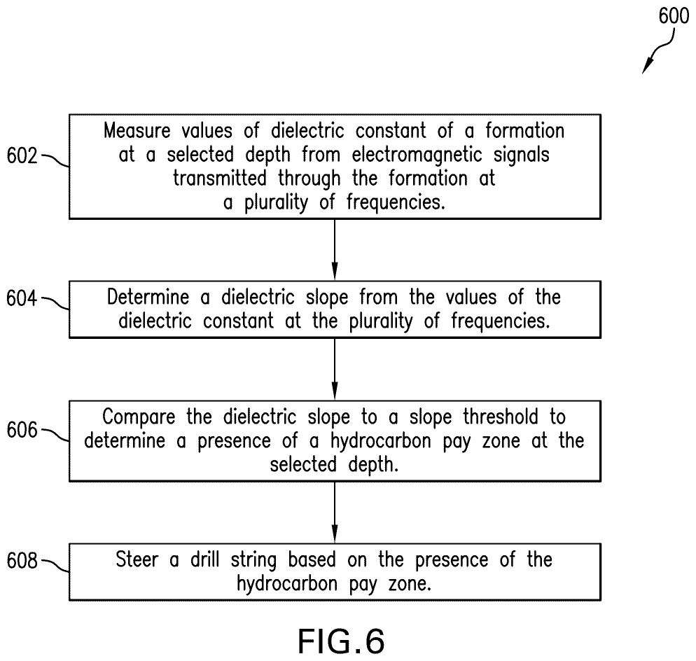

FIG. 6 is a flowchart 600 of a method for detecting a hydrocarbon pay zone at a depth in a borehole. In box 602, electromagnetic signals are transmitted through the formation at a depth of a borehole in a formation and a plurality of values of dielectric constants of a formation at the depth are measured. Each measured value of dielectric constant corresponds to a selected frequency of the electromagnetic signals. In box 604, a dielectric constant slope is calculated from the plurality of values of dielectric constants using regression analysis or other methods. In box 606, the dielectric constant slope is compared to a slope threshold to determine the presence of the hydrocarbon pay zone at the selected depth. In box 608, a drill string (such as drill string 106) is controlled to steer the drill string based on the presence of the hydrocarbon pay zone.

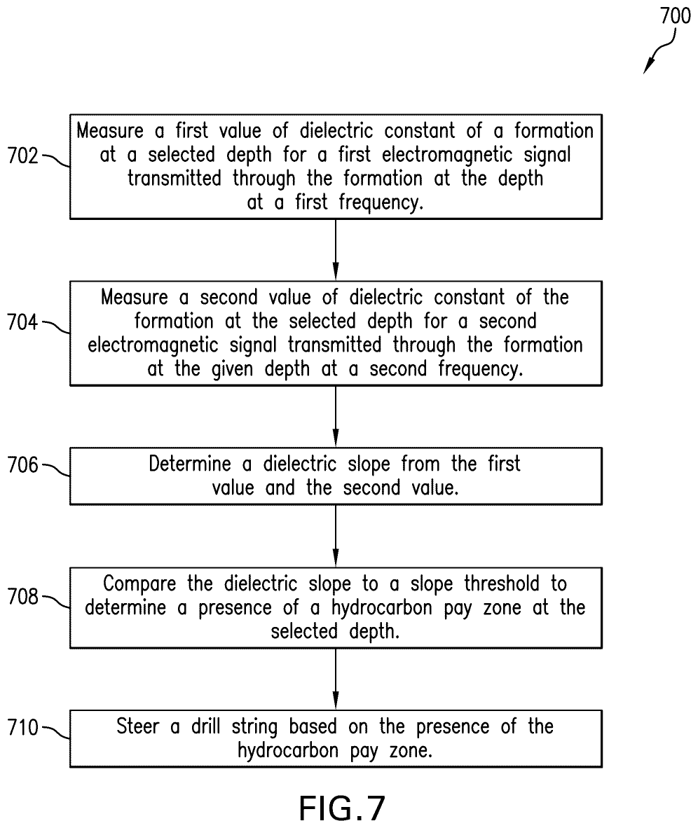

FIG. 7 is a flowchart 700 of another method for detecting a hydrocarbon pay zone at a depth in a borehole. In box 702, a first electromagnetic wave or signal is transmitted from a transmitter of the electric tool through the formation at a selected depth and received at a receiver of the electric tool. The first electromagnetic wave or signal has a first frequency. The received signal is used to determine a first value for a dielectric constant (real part) of the formation at the first frequency. In box 704, a second electromagnetic wave or signal is transmitted from the transmitter through the formation at the selected depth and at a second frequency. The second electromagnetic wave or signal is received at the receiver and is used to determine a second value for the dielectric constant of the formation at the second frequency. In box 706, a dielectric constant slope is calculated from the first value and the second value using, for example, Eq. (1) disclosed herein. In box 708, the dielectric constant slope is compared to a slope threshold to determine the presence of the hydrocarbon pay zone at the selected depth. In box 710, the drill string is controlled to steer the drill string based on the presence of the hydrocarbon pay zone.

The slope threshold can be determined using various methods. In one embodiment, the slope threshold can be determined from comparing measurements of dielectric constant slope at a given depth to the known properties of formation from any available logging or characterization methods, such as cuttings obtained from the depth while drilling or wireline logs where porosity is well characterized (as in wireline porosity log 306, FIG. 3C). This can be performed in the same drilled borehole or in a nearby borehole or a pilot hole in the same reservoir. Alternatively, the slope threshold can be determined via a simulation process where dielectric constant at various frequencies being calculated from a medium in which formation properties and hydrocarbon porosity are known and representative to the drilled formation. In another embodiment, measurements can be made of dielectric constant in a first section of the borehole where hydrocarbons are present in order to determine a suitable slope threshold. The slope threshold can then be used in a second section (generally a subsequently drilled section) of the borehole. The slope threshold can be used to determine the presence of a hydrocarbon pay zone in the second section from measurements of dielectric constant obtained in the second section. The slope threshold can be stored in a memory location or lookup table. The slope threshold can alternatively be determined using other methods, such as correlation with a template or by pattern recognition using machine learning.

Set forth below are some embodiments of the foregoing disclosure:

Embodiment 1. A method for identifying a pay zone in a formation. A first dielectric constant of the formation is measured at a selected depth or depth interval in a borehole in the formation using a first electromagnetic wave or signal transmitted through the formation at the selected depth or depth interval at a first frequency. A second dielectric constant of the formation is measured at the selected depth or depth interval in the borehole in the formation using a second electromagnetic wave or signal transmitted through the formation at the selected depth or depth interval at a second frequency. The pay zone is identified based on the first dielectric constant at the selected depth or depth interval and the second dielectric constant at the selected depth or depth interval.

Embodiment 2. The method of any prior embodiment, further comprising determining a dielectric constant slope based on the first dielectric constant and the second dielectric constant and identifying the pay zone based on the dielectric constant slope.

Embodiment 3. The method of any prior embodiment, further comprising identifying the pay zone based on a comparison of the dielectric constant slope to a dielectric constant slope threshold.

Embodiment 4. The method of any prior embodiment, wherein the pay zone is identified by using a processor in the borehole.

Embodiment 5. The method of any prior embodiment, wherein the first frequency or the second frequency are in a range from about 1 kilohertz (kHz) to about 30 Megahertz (Mhz).

Embodiment 6. The method of any prior embodiment, wherein the dielectric constant slope is determined by using a processor in the borehole.

Embodiment 7. The method of any prior embodiment, wherein the first frequency or the second frequency are in a range from about 100 kilohertz (kHz) to about 10 Megahertz (Mhz).

Embodiment 8. The method of any prior embodiment, further comprising determining the dielectric constant slope threshold using measurements obtained in a first section of the borehole and wherein the selected depth or depth interval is in a second section of the borehole different from the first section.

Embodiment 9. The method of any prior embodiment, further comprising steering a drill string based on the identification of the pay zone.

Embodiment 10. A borehole system including a processor configured to measure a first dielectric constant of the formation at a selected depth or depth interval in a borehole in the formation using a first electromagnetic wave or signal transmitted through the formation at the selected depth or depth interval at a first frequency, measure a second dielectric constant of the formation at the selected depth or depth interval in the borehole in the formation using a second electromagnetic wave or signal transmitted through the formation at the selected depth or depth interval at a second frequency, and identify a pay zone in the formation based on the first dielectric constant at the selected depth or depth interval and the second dielectric constant at the selected depth or depth interval.

Embodiment 11. The borehole system of any prior embodiment, wherein the processor is further configured to determine a dielectric constant slope based on the first dielectric constant and the second dielectric constant and identify the pay zone based on the dielectric constant slope.

Embodiment 12. The borehole system of any prior embodiment, wherein the processor is further configured to identify the pay zone based on a comparison of the dielectric constant slope to a dielectric constant slope threshold.

Embodiment 13. The borehole system of any prior embodiment, wherein the processor is in the borehole.

Embodiment 14. The borehole system of any prior embodiment, wherein the first frequency or the second frequency are in a range from about 1 kilohertz (kHz) to about 30 Megahertz (Mhz).

Embodiment 15. The borehole system of any prior embodiment, wherein the dielectric constant slope is determined by using a processor in the borehole.

Embodiment 16. The borehole system of any prior embodiment, wherein the first frequency or the second frequency are in a range from about 100 kilohertz (kHz) to about 10 Megahertz (Mhz).

Embodiment 17. The borehole system of any prior embodiment, wherein the processor is further configured to determine the dielectric constant slope threshold using measurements obtained in a first section of the borehole and wherein the selected depth or depth interval is in a second section of the borehole different from the first section.

Embodiment 18. The borehole system of any prior embodiment, wherein the processor is further configured to steer a drill string based on the identification of the pay zone.

The use of the terms “a” and “an” and “the” and similar referents in the context of describing the invention (especially in the context of the following claims) are to be construed to cover both the singular and the plural, unless otherwise indicated herein or clearly contradicted by context. Further, it should be noted that the terms “first,” “second,” and the like herein do not denote any order, quantity, or importance, but rather are used to distinguish one element from another. The terms “about”, “substantially” and “generally” are intended to include the degree of error associated with measurement of the particular quantity based upon the equipment available at the time of filing the application. For example, “about” and/or “substantially” and/or “generally” can include a range of +8% a given value.

While the invention has been described with reference to an exemplary embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the claims. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited.

What is claimed is:

1. A method for identifying a pay zone in a formation, comprising:
measuring a first dielectric constant of the formation at a selected depth or depth interval in a borehole in the formation using a first electromagnetic wave or signal transmitted through the formation at the selected depth or depth interval at a first frequency;
measuring a second dielectric constant of the formation at the selected depth or depth interval in the borehole in the formation using a second electromagnetic wave or signal transmitted through the formation at the selected depth or depth interval at a second frequency; and
identifying the pay zone based on the first dielectric constant at the selected depth or depth interval and the second dielectric constant at the selected depth or depth interval.

2. The method of claim 1, further comprising determining a dielectric constant slope based on the first dielectric constant and the second dielectric constant and identifying the pay zone based on the dielectric constant slope.

3. The method of claim 2, further comprising identifying the pay zone based on a comparison of the dielectric constant slope to a dielectric constant slope threshold.

4. The method of claim 1, wherein the pay zone is identified by using a processor in the borehole.

5. The method of claim 1, wherein the first frequency or the second frequency are in a range from about 1 kilohertz (kHz) to about 30 Megahertz (Mhz).

6. The method of claim 2, wherein the dielectric constant slope is determined by using a processor in the borehole.

7. The method of claim 5, wherein the first frequency or the second frequency are in a range from about 100 kilohertz (kHz) to about 10 Megahertz (Mhz).

8. The method of claim 3, further comprising determining the dielectric constant slope threshold using measurements obtained in a first section of the borehole and wherein the selected depth or depth interval is in a second section of the borehole different from the first section.

9. The method of claim 1, further comprising steering a drill string based on the identification of the pay zone.

10. A borehole system, comprising:
a processor configured to:
measure a first dielectric constant of a formation at a selected depth or depth interval in a borehole in the formation using a first electromagnetic wave or signal transmitted through the formation at the selected depth or depth interval at a first frequency;
measure a second dielectric constant of the formation at the selected depth or depth interval in the borehole in the formation using a second electromagnetic wave or signal transmitted through the formation at the selected depth or depth interval at a second frequency; and
identify a pay zone in the formation based on the first dielectric constant at the selected depth or depth interval and the second dielectric constant at the selected depth or depth interval.

11. The borehole system of claim 10, wherein the processor is further configured to determine a dielectric constant slope based on the first dielectric constant and the second dielectric constant and identify the pay zone based on the dielectric constant slope.

12. The borehole system of claim 11, wherein the processor is further configured to identify the pay zone based on a comparison of the dielectric constant slope to a dielectric constant slope threshold.

13. The borehole system of claim 10, wherein the processor is in the borehole.

14. The borehole system of claim 10, wherein the first frequency or the second frequency are in a range from about 1 kilohertz (kHz) to about 30 Megahertz (Mhz).

15. The borehole system of claim 11, wherein the dielectric constant slope is determined by using a processor in the borehole.

16. The borehole system of claim 14, wherein the first frequency or the second frequency are in a range from about 100 kilohertz (kHz) to about 10 Megahertz (Mhz).

17. The borehole system of claim 12, wherein the processor is further configured to determine the dielectric constant slope threshold using measurements obtained in a first section of the borehole and wherein the selected depth or depth interval is in a second section of the borehole different from the first section.

18. The borehole system of claim 10, wherein the processor is further configured to steer a drill string based on the identification of the pay zone.
